(19) United States
(12) Patent Application Publication
(10) Pub. No.: US 2019/0093484 A1
(43) Pub. Date: Mar. 28, 2019

(54) GAS TURBINE BLADE

(71) Applicant: DOOSAN HEAVY INDUSTRIES & CONSTRUCTION CO., LTD., Changwon-si (KR)

(72) Inventor: Yun Chang Jang, Gimhae-si (KR)

(21) Appl. No.: 16/005,681

(22) Filed: Jun. 12, 2018

(30) Foreign Application Priority Data
Sep. 27, 2017 (KR) 10-2017-0125155

(51) Int. Cl. F01D 5/18

(52) U.S. Cl. CPC F01D 5/186; F05D 2250/52; F05D 2260/2214; F05D 2260/202

(57) ABSTRACT

A gas turbine blade includes a turbine blade having an outer surface divided according to surface sections arranged from a leading edge to a trailing edge; a plurality of film cooling holes formed in the outer surface, each film cooling hole including a cooling channel and an outlet communicating with the cooling channel to discharge cooling air to the outer surface; and a protrusion formed on an inside surface of the outlet of at least one film cooling hole disposed in exactly one surface section of the outer surface. The blade's outer surface is divided into three surface sections respectively corresponding to thirds of a length of the outer surface, from the leading edge to the trailing edge, and including first and third surface sections adjacent to the leading and trailing edges, respectively, and a second surface section in which the protrusion occurs between the first and third surface sections.

### CROSS-REFERENCE TO RELATED APPLICATIONS

This application claims priority to Korean Patent Application No. 10-2017-0125155, filed on Sep. 27, 2017, the disclosure of which is incorporated herein by reference in its entirety.

### BACKGROUND OF THE DISCLOSURE

### Field of the Disclosure

The present disclosure relates to a gas turbine blade provided in a gas turbine, and more particularly, to a gas turbine blade employing film cooling.

### Description of the Related Art

A gas turbine is a type of an internal combustion engine that converts thermal energy into mechanical energy. A high-temperature, high-pressure combustion gas is generated by mixing fuel with air compressed at a high pressure in a compressor and combusting the mixture. The gas is discharged into a turbine, which acts against a series of turbine blades and thus rotates the turbine. A widely used turbine configuration includes a plurality of turbine rotor disks each having an outer circumferential surface on which a plurality of gas turbine blades are arranged in multiple stages. The combustion gas passes through each stage of arranged turbine blades. In doing so, the turbine blades are subject to very high temperatures, which jeopardizes the integrity of the turbine components under high pressure. This especially affects the turbine blades.

To counteract these effects and to avert failure of turbine blades in gas turbine engines resulting from excessive operating temperatures, gas turbine blades generally employ a film cooling technique which has been applied blade designs in order to cool the blade surfaces. In film cooling, relatively cool air obtained from the compressor is ducted to internal chambers of the turbine blades and discharged through small holes provided in the blade walls. This air provides a thin, cool, insulating blanket along the external surfaces of the turbine blade.

FIG. 1 shows two views of a film cooling hole 7 formed in a contemporary turbine blade (not shown) which has a plurality of such film cooling holes arranged across outer surfaces of the turbine blade. Each film cooling hole 7 discharges cooling air onto blade surfaces that are adjacent to the hole's outlet.

The film cooling hole 7 includes an inlet 7a having a circular cross-section through which flows the cooling air supplied to the interior of the turbine blade, and an extension portion 7b extending from the inlet 7a to the turbine blade surface (not shown) where the cooling air is discharged. The extension portion 7b performs a diffusion of the cooling air to be discharged, and a specific diffusion angle α is formed with respect to the inlet 7a. This diffusion is to enhance the effect of a large amount of cooling air being supplied to the surface through the extension portion 7b. However, as the diffusion angle α increases, a separation phenomenon is unevenly caused inside the expansion portion 7b, whereby the flow of cooling air onto the blade surface is inconsistent and uneven.

In particular, the cooling air flowing out in middle areas of a suction surface and a pressure surface of the turbine blade is unstably delivered to the blade surface. The surface temperature of the turbine blade increases in these surface areas, which in turn suffer localized heat stress such that blade surface deformation or cracking may occur.

Accordingly, there is a need for a method to achieve stable cooling by changing the structure of the film cooling hole of the turbine blade.

### SUMMARY OF THE DISCLOSURE

Exemplary embodiments of the present disclosure provide a gas turbine blade that forms a protrusion inside a film cooling portion provided in a gas turbine blade, and changes an internal structure so that the cooling air faces the surface of the turbine blade.

A gas turbine blade in accordance with the present disclosure may include a turbine blade having an outer surface extending between a leading edge and a trailing edge, the outer surface being divided according to surface sections arranged from the leading edge to the trailing edge; a plurality of film cooling holes formed in the outer surface, each film cooling hole including a cooling channel extending inside the turbine blade to guide cooling air toward the outer surface, and an outlet communicating with the cooling channel to discharge cooling air to the outer surface; and a protrusion formed on an inside surface of the outlet of at least one film cooling hole disposed in exactly one surface section of the outer surface.

The outer surface may be divided into three surface sections respectively corresponding to thirds of a length of the outer surface from the leading edge to the trailing edge and including a first surface section arranged adjacent to the leading edge; a third surface section arranged adjacent to the trailing edge; and a second surface section arranged between the first and third surface sections, wherein the at least one film cooling hole is disposed in the second surface section. Preferably, the protrusion is not present in the film cooling holes formed in the first and third surface sections of the outer surface.

The inside surface of the outlet may be inclined at a predetermined angle with respect to a direction of hot gas moving toward the turbine blade.

The protrusions of the at least one film cooling hole may have a constant height.

The outlet may have one end communicating with the outer surface, and the protrusions of the at least one film cooling hole may increase in height toward the one end.

The outlets of the plurality of film cooling holes may each have an opening for discharging the cooling air to the outer surface, the openings decreasing in area toward a tip of the turbine blade.

The outlets may each include one end communicating with the outer surface of the turbine blade. A curved portion may be provided at the one end of the outlet of a film cooling hole formed in the outer surface of the turbine blade toward the tip of the turbine blade. The curved portion may be inclined for spraying cooling air onto the outer surface of the turbine blade.

The outer surface may be divided into surface sections respectively corresponding to portions of a length of the outer surface from the leading edge to the trailing edge, wherein the at least one film cooling hole is disposed in a specific surface section of the divided outer surface, and the protrusion is not present in the film cooling holes formed in the surface sections of the outer surface excluding the specific surface section.

The protrusions of the at least one film cooling hole may decrease in height toward a tip of the turbine blade.

The tip of the turbine blade may include a curved portion to spray cooling air from the outlet onto the outer surface of the turbine blade, the curved portion being inclined at a predetermined angle with respect to a direction of hot gas moving toward the turbine blade.

The outlet may include two inside surfaces facing each other, and the curved portion includes one of the two inside surfaces. The other of the two inside surfaces of the outlet may include a first inclination and is inclined toward the curved portion of the outlet. The protrusions may be respectively formed on the two inside surfaces of the outlet.

The outer surface may be divided into surface sections respectively corresponding to portions of a length of the outer surface from the leading edge to the trailing edge, the surface sections including a specific surface section of the divided outer surface, and the film cooling holes may be configured differently in the specific surface section than in the surface sections other than the specific surface section. The protrusions of the specific surface section may be configured differently according to a distance from a hub of the turbine blade.

The film cooling hole may be formed with an inside surface having a low friction coefficient with respect to cooling air moving through the outlet.

A gas turbine blade in accordance with another aspect of the present disclosure may include a turbine blade having an outer surface extending between a leading edge and a trailing edge, the outer surface being divided according to surface sections arranged from the leading edge to the trailing edge; and a plurality of film cooling holes formed in the outer surface, each film cooling hole including a cooling channel extending inside the turbine blade to guide cooling air toward the outer surface, and an outlet communicating with the cooling channel to discharge cooling air to the outer surface, wherein the outer surface is divided into surface sections respectively corresponding to portions of a length of the outer surface from the leading edge to the trailing edge, the surface sections including a specific surface section of the divided outer surface, and wherein the film cooling holes are configured differently in the specific surface section than in the surface sections other than the specific surface section. The film cooling holes of only the specific surface section may be configured differently according to a distance from a hub of the turbine blade, and the gas turbine blade may further include a protrusion formed on an inside surface of the outlet of at least one film cooling hole disposed in the specific surface section.

The embodiments of the present disclosure can enhance heat transfer performance through the plurality of protrusions provided in the outlet and can perform the cooling by guiding the movement direction of the cooling air sprayed onto the surface of the turbine blade through the film cooling hole. Further, the embodiments can minimize the local temperature rise by enhancing the cooling efficiency for the surface of the turbine blade and can stably maintain the cooling efficiency in a specific section of the blade's outer surface comprised of the suction surface and the pressure surface.

### BRIEF DESCRIPTION OF THE DRAWINGS

FIG. 1 is a diagram of a film cooling hole portion formed in a turbine blade according to a related art.

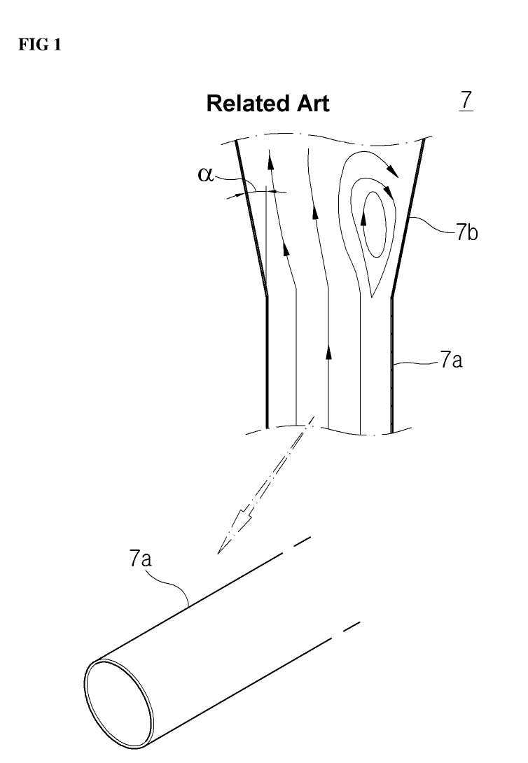

FIG. 2 is a longitudinal cross-sectional diagram of a gas turbine in which a gas turbine blade of the present disclosure is installed.

FIG. 3 is a perspective view of a gas turbine blade according to an embodiment of the present disclosure, including an enlarged perspective view of a film cooling hole of the gas turbine blade.

FIG. 4 is a cross-sectional view of an outlet of a film cooling hole of a gas turbine blade according to an embodiment of the present disclosure, illustrating a protrusion disposed within the film cooling hole.

FIG. 5 is a perspective view of the structure of a film cooling hole of a gas turbine blade according to another embodiment of the present disclosure.

FIG. 6 is an operational diagram of the gas turbine blade in accordance with a first embodiment of the present disclosure.

FIG. 7 is an operational diagram of the gas turbine blade in accordance with a second embodiment of the present disclosure.

### DESCRIPTION OF SPECIFIC EMBODIMENTS

Before explaining the present disclosure, a configuration of a gas turbine will be described with reference to the drawings.

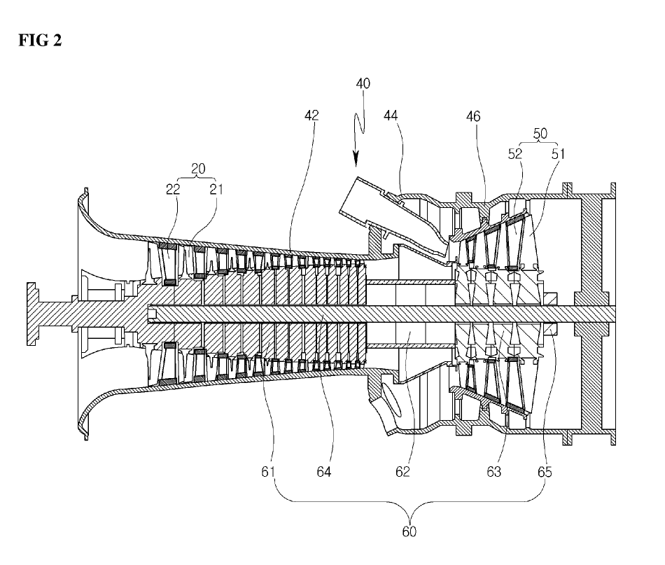

Referring to FIG. 2, a gas turbine includes a casing 10 giving an external shape to the gas turbine, a compressor section 12 located toward the upstream end of the casing 10, and a turbine section 30 located toward the downstream end. The downstream end of the casing 10 is provided with a diffuser through which a combustion gas passing through the turbine is discharged. A number of combustors 11 that receive and combust the air compressed are located upstream of the diffuser and are arranged around the circumference of the casing 10.

A torque tube 14 that delivers a rotation torque generated in the turbine section 30 to the compressor section 12 is interposed between the compressor section 12 and the turbine section 30.

The compressor section 12 is provided with a plurality (e.g., fourteen) of compressor rotor disks, which are held together in the axial direction by a tie rod 15 having one end fastened in the first compressor rotor disk and the other end fixed to the torque tube. That is, the compressor rotor disks are arranged along the axis direction and each has the tie rod 15 penetrating the center thereof. A flange protrudes in the axis direction and is coupled to prevent the rotation relative to the adjacent rotor disk. The configuration of the tie rod 15 may vary depending upon the gas turbine and is not limited to the configuration illustrated in the drawings. For example, one tie rod may penetrate the central portion of the rotor disks, a plurality of tie rods may be arranged along the circumferential direction, or a combination of these configurations may be used.

A plurality of blades are radially coupled to the outer circumferential surface of the compressor rotor disk. Each blade has a dovetail portion to be fastened to the compressor rotor disk. The fastening method of the dovetail portion includes a tangential type and an axial type. This can be selected depending upon the required structure of the gas turbine commonly used. In some cases, the blade can be fastened to the rotor disk using another fastener other than the dovetail.

Although not shown, the compressor may be may be provided with a vane functioning as a guide vane, called a deswirler, for next location of the diffuser in order to adjust the flowing angle of fluid entering the inlet of the combustor after increasing the pressure of fluid to the design flow angle.

The combustor 11 produces a high-temperature, high-pressure combustion gas of high energy by mixing the incoming compressed air with a fuel and combusting the mixture. The temperature of the combustion gas is generally as high as a heat-resistant limitation that the combustor and turbine parts can withstand in the constant pressure combustion process.

Plural combustors constituting a combustion system of the gas turbine can be arranged in the casing formed in the cell shape, and each combustor is configured to include a burner including a fuel spray nozzle, etc., a combustor liner forming a combustion chamber, and a transition piece becoming a connection portion of the combustor and the turbine.

Specifically, the liner provides a combustion space where the fuel sprayed by a fuel nozzle is mixed with the compressed air of the compressor and combusted. The liner can include a flame barrel providing the combustion space where the fuel mixed with the air is combusted, and a flow sleeve forming an annular space while surrounding the flame barrel. In addition, the fuel nozzle is coupled to the front end of the liner, and an ignition plug is coupled to the side wall thereof.

Meanwhile, the transition piece is connected to the rear end of the liner in order to transmit the combustion gas combusted by the ignition plug to the turbine side.

The transition piece cools the outer wall portion thereof by the compressed air supplied from the compressor in order to prevent combustion gas from being damaged by high temperature.

For this purpose, the transition piece is provided with holes for the cooling to spray the air into the inner portion thereof, and the compressed air is flowed to the liner side after cooling the internal body through the holes.

The cooling air cooling the transition piece described above is flowed in the annular space of the liner. The compressed air can be provided from the outside of the flow sleeve and introduced into the cooling air through the cooling holes provided in the flow sleeve to then collide against the outer wall of the liner.

Meanwhile, generally, the turbine expands the high-temperature, high-pressure combustion gas coming from the combustor and converts it into mechanical energy by applying the impulsive and repulsive force to the rotation wing of the turbine.

The mechanical energy obtained in the turbine is supplied as the energy required for compressing the air in the compressor, and the rest is used to operate a generator to generate the power.

In the turbine, a plurality of stators and rotors are alternatively arranged in the vehicle room, and the rotor is operated by the combustion gas to rotate the output shaft to which the generator is connected.

For this purpose, the turbine section 30 is provided with a plurality of turbine rotor disks, and each of the turbine rotor disks basically has the shape similar to the compressor rotor disk.

The turbine rotor disk also has a flange for coupling with a neighboring turbine rotor disk, and includes a plurality of turbine blades radially located. The turbine blade can be also coupled to the turbine rotor disk in the dovetail method.

In the gas turbine having the above structure, the incoming air is compressed in the compressor section 12, combusted in the combustor 11, then moved to the turbine section 30 to operate the turbine and discharged to the atmosphere through the diffuser.

A representative method for increasing the efficiency of the gas turbine includes increasing the temperature of the gas flowed into the turbine section 30, but in this case, the phenomenon increasing the inlet temperature of the turbine section 30 is caused.

In addition, a problem is caused in the turbine blade provided in the turbine section 30 and the temperature of the turbine blade locally increases to generate thermal stress. If the thermal stress is maintained for a long time, deformation by way of a creep phenomenon can lead to the destruction of the turbine blade.

In order to compensate for the problems generated in the turbine blade described above, the cooling air is supplied to the inside of the turbine blade. The cooling air performs the cooling while flowing along a flow path formed inside the turbine blade.

A gas turbine blade in accordance with an embodiment of the present disclosure will be described with reference to the drawings.

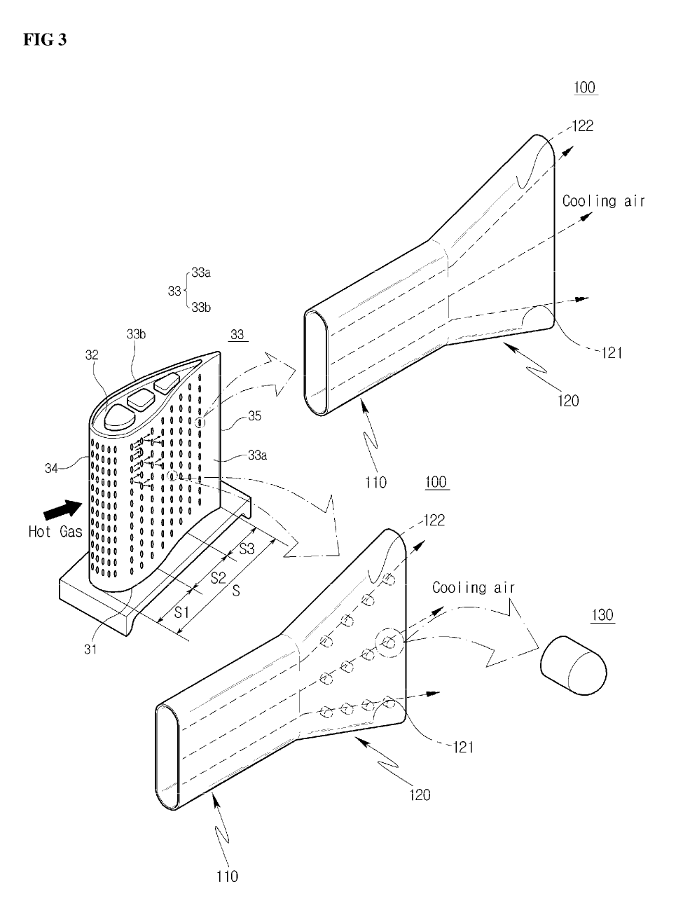

Referring to FIG. 3, the gas turbine blade in accordance with a first embodiment of the present disclosure realizes stable surface cooling (film cooling) when a high-temperature hot gas is applied to surfaces of the turbine blade. In this case, the present disclosure performs film cooling for an outer surface 37 of a turbine blade 33 through a film cooling hole 100 that can deliver the cooling air, which has been supplied to the inside of the turbine blade 33, to the outer surface of the turbine blade 33. The outer surface 37 comprises a pressure surface 33a and a suction surface 33b. A high-temperature hot gas moves along the outer surface 37 of the turbine blade 33, thereby achieving the film cooling of the surfaces of the turbine blade 33.

For this purpose, the present disclosure is provided with a plurality of film cooling holes 100 formed in the outer surface 37 of the turbine blade 33, from a leading edge 34 to a trailing edge 35 of the turbine blade 33. The film cooling holes 100 are provided for the cooling air to be supplied from the inside of the turbine blade 33 and then sprayed to the surface thereof to achieve the film cooling. Each film cooling hole 100 includes a cooling channel 110 extending inside the turbine blade 33 to guide cooling air toward the outer surface 37, and an outlet 120 communicating with the cooling channel 110 to discharge cooling air to the outer surface 37.

In order to stably and evenly supply the cooling air throughout the outer surface 37, including to surface areas difficult for cooling air to reach or surface areas which exhibit low or limited flow of cooling air, the structure of the film cooling holes 100 is varied as illustrated in the drawings, thus achieving stable and even cooling. For this purpose, the present invention is provided with the film cooling holes 100, formed in the outer surface 37, across three surface sections arranged from a leading edge 34 of the turbine blade 33 to a trailing edge 35 thereof.

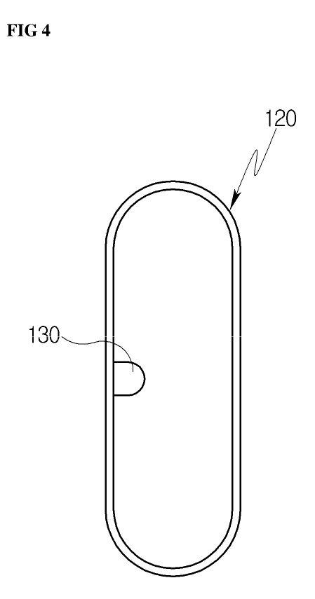

In general, the cross-section of the outlet 110 has an oblong shape with two flat sides and two rounded ends, as shown in FIGS. 3-5. Meanwhile, the cooling channel 110 may have a circular cross-section to be generally cylindrical according to an embodiment, but alternatively the cross-section may have an oblong shape with two flat sides and two rounded ends, as shown in FIG. 3. One end of the cooling channel 110 is connected to the inside of the turbine blade 33 so that the cooling air is flowed. The other end of the cooling channel 110 is extended toward the outside of the turbine blade 33 and is joined with the outlet 120.

For reference, the outlet 120 is formed with inside walls 121, 122 facing each other therein.

As cooling air is supplied to and moves through the outlet 120, the film cooling holes 100 performs heat exchange between the moving cooling air and the surface area of the inside surfaces of the outlet 120 and stably diffuses the cooling air toward the outer surface 37 of the turbine blade 33 to reduce the high temperature of the hot gas to a predetermined temperature, thus achieving the cooling.

The outer surface 37 of the turbine blade 33 extends between the leading edge 34 and the trailing edge 35 and is divided into surface sections arranged from the leading edge 34 to the trailing edge 35. Meanwhile, at least one film cooling hole 100 among the plurality of film cooling holes 100 has a protrusion 130 formed on an inside surface of the outlet 120. The film cooling hole 100 in which the protrusion is formed is disposed in exactly one surface section of the outer surface 37.

When dividing the outer surface 37 into three sections from the leading edge 34 to the trailing edge 35, the length of the turbine blade 33 corresponds to a length (S) of the outer surface 37 from the leading edge 34 to the trailing edge 35. The three surface sections include a first surface section S1 corresponding to the S/3 location based on the leading edge 34, a second surface section S2 corresponding to the 2S/3 location of the bending section (S) from the end portion of the first surface section S1, and a third surface section S3 corresponding to the rest section from the end portion of the second surface section S2 to the trailing edge 35. In other words, the outer surface 37 is divided into three surface sections respectively corresponding to thirds of the length of the outer surface 37, from the leading edge 34 to the trailing edge 35, and comprises first, second, and third surface sections S1, S2, and S3. The first surface section S1 is arranged adjacent to the leading edge 34; the second surface section S2 is arranged between the first and third surface sections S1 and S3; and the third surface section S3 is arranged adjacent to the trailing edge 35.

Although the drawings show the outer surface 37 divided into three sections, the present invention is not limited to such division of the outer surface 37. That is, the outer surface 37 may be divided into any number of surface sections respectively corresponding to portions of a length (S) of the outer surface 37 from the leading edge 34 to the trailing edge 35, the surface sections including a specific surface section of the divided outer surface. The film cooling holes 100 are configured differently in the specific surface section, where the protrusion 130 occurs, than in the surface sections other than the specific surface section. In a preferred embodiment, the specific surface section is the second surface section S2.

The protrusion 130 is disposed in the second surface section S2, which substantially corresponds to a concave portion of the pressure surface 33a and to a convex portion of the suction surface 33b. The configuration of the protrusion 130 is not limited to the shapes illustrated in the drawings and may have a circular cross-sectional surface, a polygonal cross-sectional surface, a D-shaped cross-sectional surface, or a combination thereof.

Cooling achieved for the pressure surface 33a and the suction surface 33b is advantageously enhanced in terms of effect and efficiency, if the cooling air supplied from the film cooling hole 100 to the blade surface moves while in close contact with the surface and without the separation from the surface. For this purpose, the present embodiment includes the protrusion 130 only in the second surface section S2 among the three sections of the turbine blade 33, thus enhancing the cooling efficiency, and in addition, locates the protrusion 130 to limit to the following location.

As an example, the protrusion 130 formed in the second surface section S2 is located on the inside surface inclined at a predetermined angle with respect to the movement direction of the hot gas moving toward the turbine blade 33.

The cooling air is changed in the movement direction by the protrusion 130 at the outlet 120 to be attached to the surface of the turbine blade 33, and sprayed in the direction illustrated by the arrows of FIG. 3.

The protrusion 130 guides the movement direction of the cooling air, and guides the cooling air to the surface of the turbine blade 33 by changing the flow of the cooling air depending upon the location of the protrusion 130.

Thus, the cooling air performs the cooling by mixing with the hot gas and stably moving without separation from the surface of the turbine blade 33 when the spray direction of the cooling air is changed at the outlet 120 and the cooling air is sprayed on the surface of the turbine blade 33.

Accordingly, the performance of the turbine blade 33 is enhanced by stable cooling in the second surface section S2 where, according to a contemporary art, the cooling by the film cooling hole 100 is relatively disadvantageous.

The turbine blade 33 has no protrusion 130 formed in the first or third surface sections S1 or S3, where only the movement of the cooling air inside the film cooling hole 100 is applied in a transfer of heat from the turbine blade 33 to the cooling air. Thus, in this configuration, there is no additional heat transfer effected in the first and third surface sections S1 and S3 by the presence of a protrusion 130.

The protruded height of the protrusion 130 in accordance with the present embodiment is, as an example, constantly maintained, and the protrusion 130 is, as an example, configured in any one shape of cylindrical, polygonal, or elliptical.

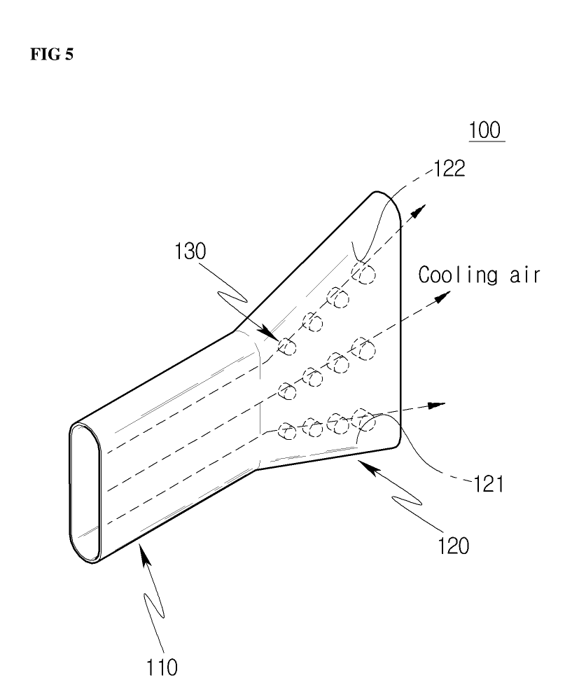

Referring to FIG. 5, the protruded height of the protrusion 130 in accordance with the present embodiment is increased toward the outlet 120. The protruded height of the protrusion 130 can be variously changed considering the height of the outlet 120, thus achieving the enhancement of heat transfer performance by increasing the protruded height to increase the contact area with the cooling air accordingly.

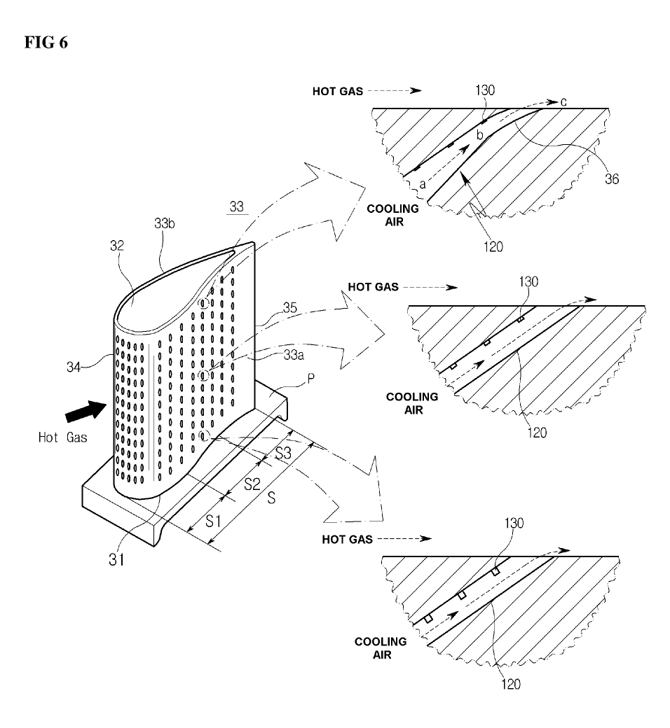

Referring to FIG. 6, the turbine blade 33 in accordance with the present embodiment includes a hub 31 connected to a platform P supporting the turbine blade 33, and a tip 32 formed at the distal end of the turbine blade 33 extended from the hub 31. The protruded height of the protrusion 130 is reduced from the hub 31 toward the tip 32. Upon rotation of the turbine blade 33, the speed of the turbine blade 33 generated at the tip 32 is faster than the speed generated at the hub 31. Using the rotational speed differential according to blade surface location, since the hot gas moving toward the turbine blade 33 moves faster against the tip 32 than against the hub 31, the temperature of the turbine blade 33 at the tip 32 can be lower than the temperature of the turbine blade 33 at the hub 31. In other words, the turbine blade 33 can more readily be cooled at the tip 32 than at the hub 31.

In the present embodiment, the protruded height of the protrusion 130 at the tip 32 using the characteristics of the turbine blade 33 can be configured to be small or flat. In addition, since the protruded length of the protrusion 130 at the hub 31 is extended longer than at the tip 32, the heat transfer area is increased, thus enhancing the cooling performance.

The turbine blade 33 in accordance with the present embodiment includes the hub 31 and the tip 32, and can be configured so that the area of the outlet 120 is reduced from the hub 31 toward the tip 32.

The opening area of the outlet 120 is generally maintained constantly, but the present embodiment can induce the movement direction of the cooling air sprayed on the surface of the turbine blade 33 to the surface thereof by changing the area of the outlet 120 to variously adjust the spray speed of the cooling air.

The outlet 120 is formed with a curved portion 36 inclined for the cooling air to be sprayed on the surface of the turbine blade 33.

The curved portion 36 is rounded by the curvature illustrated in the drawing and guides the movement of the cooling air as illustrated as the arrow.

The curved portion 36 is formed to guide the cooling air to move in close contact with the surface of the turbine blade 33 when the cooling air is sprayed to the outside through the outlet 120.

As an example, as indicated in FIG. 6, the curved portion 36 can guide the cooling air from the “a” location to the “b” location and finally to the “c” location, which is the surface of the turbine blade 33, thus minimizing the temperature rise of the turbine blade 33 due to the hot gas and achieving the stable cooling.

As an example, the outlet 120 is configured so that the area of the outlet 120 at the film cooling hole 100 located adjacent to the tip 32 is smaller than the area of the outlet 120 of the film cooling hole 100 located adjacent to the hub 31, thus increasing the spray speed of the cooling air. Here, the area of the outlet 130 refers to a cross-section of the outlet 130 taken at the blade surface where the cooling air exits the outlet 130.

The present embodiment can provide the gas turbine having the turbine blade 33 having the protrusion 130 formed on the film cooling hole 100, or be applied to a turbine apparatus requiring the cooling.

The height of the protrusion 130 in accordance with the present embodiment is linearly increased toward the outlet 120. For example, if the height thereof is linearly increased at a constant rate toward the protrusion located at the inside end portion of the outlet 120 based on the protrusion 130 located at the location firstly contacting with the cooling air, the flow of the cooling air is made as stable as possible.

In this case, the heat exchange efficiency depending upon the movement of the cooling air on the inside surface of the film cooling hole 100 is enhanced, such that it is advantageous in terms of the cooling efficiency.

The film cooling hole 100 is produced to have a low friction coefficient with respect to cooling air and inside surfaces of the film cooling hole 100 where the cooling air makes contact while moving toward the outer surface 37. In particular, the film cooling hole 100 is formed with an inside surface having a low friction coefficient with respect to cooling air moving through the outlet 120. In this case, the movement stability of the cooling air passing through the outlet 120 is enhanced. In addition, the direction of the cooling air sharply changed during the movement or the loss occurrence due to an eddy current is minimized, thus enhancing the movement stability.

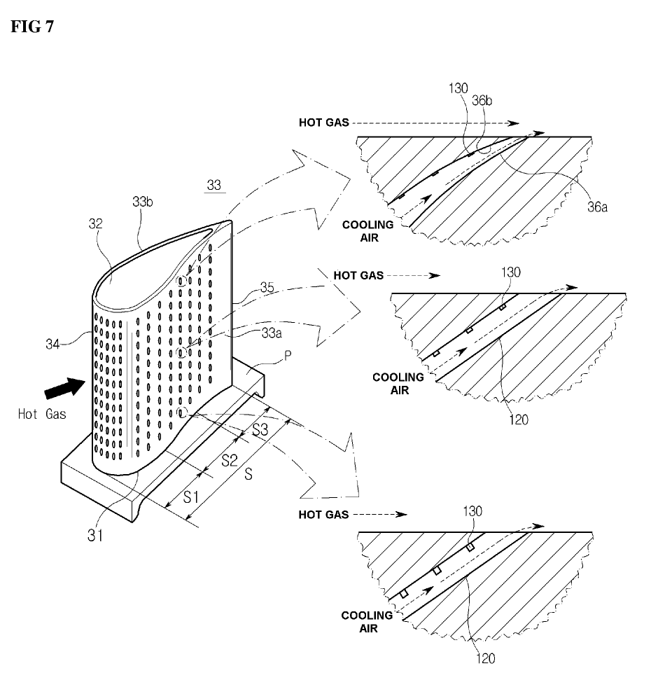

A gas turbine blade in accordance with a second embodiment of the present disclosure will be described with reference to FIG. 7. In the present embodiment, unlike the first embodiment of FIG. 6 described above, a first inclination portion 36b and a curved portion 36a face each other at an end portion of the outlet 120. In this case, since the opening area of the outlet 120 is narrowed toward the outside end portion thereof, the moving speed of the cooling air is fast due to the nozzle effect. This effect of increasing the moving speed of the cooling air mixed with the hot gas will be described later.

Referring to FIG. 7, the gas turbine blade in accordance with the present embodiment includes the turbine blade 33 having the pressure surface 33a and the suction surface 33b, and the film cooling hole 100 having the cooling channel 110 extended toward the outside from the inside of the turbine blade 33, and the outlet 120 through which the cooling air is discharged. The film cooling hole 100 has the protrusion 130 formed on the outlet 120 in exactly one section of a length (S) extended from the leading edge 34 of the turbine blade 33 toward the trailing edge 35 of the turbine blade 33. The protruded height of the protrusion 130 is reduced from the hub 31 toward the tip 32, and the tip 32 of the turbine blade 33 includes the curved portion 36a provided inside the outlet 120. The curved portion 36a is inclined at a predetermined angle with respect to the direction of the hot gas moving toward the turbine blade 33, in order to be sprayed onto the surface of the turbine blade 33.

The turbine blade 33 is extended with the pressure surface 33a and the suction surface 33b and is composed of the cooling channel 110 extended from the inside of the turbine blade 33 toward the outside thereof, and the film cooling hole 100 having the outlet 120 through which the cooling air is discharged.

The curved portion 36a in accordance with the present embodiment is formed on the end portion of the outlet 120 extended toward the turbine blade 33. The outlet 120 is formed at a predetermined length, and if the curved portion 36a is formed at the location, it can guide the cooling air to the surface of the turbine blade 33, whereby the cooling of the turbine blade 33 is more advantageous.

Since the turbine blade 33 is configured in plural, it is possible to safely protect the turbine blade 33 from stress concentration and cracking due to heat deformation, even when the temperature is lowered by only a few degrees compared to the convention.

In addition, if the turbine blade 33 is used for a long time, it is possible to minimize the cost occurrence due to the durability enhancement and the replacement.

The curved portion 36a is formed on the inside bottom surface of the outlet 120. The outlet 120 is extended to be inclined at a predetermined length on the extended end portion of the cooling channel 110 based on the cross-sectional diagram thereof. And, the curved portion 36a is extended to be rounded on the inclined end portion toward the surface of the turbine blade 33.

The curvature of the curved portion 36a can be extended as illustrated in the drawings, but the end portion extended toward the turbine blade 33 can be extended in the length illustrated in the drawing, or lengthily extended in the X-axis direction based on the drawing, relatively.

The film cooling hole 100 is formed with the first inclination portion 36b whose the opposite surface facing the curved portion 36a is inclined toward the end portion of the outlet 120. The first inclination portion 36b is located to face the curved portion 36a described above, and the movement direction of the cooling air is inclined at a predetermined angle toward the curved portion 36a in order to move along the curved portion 36a.

Since the outlet 120 is formed in the nozzle shape by the curved portion 36a and the first inclination portion 36b, the moving speed is increased when the cooling air is sprayed on the surface of the turbine blade 33 through the outlet 120, and the cooling of the turbine blade 33 can be intensively sprayed on the region where the cooling of the turbine blade 33 is required.

When the moving speed is increased, a larger amount of the cooling air per unit time can be sprayed on the surface of the turbine blade 33, thus enhancing the film cooling performance of the turbine blade 33.

In this case, the cooling is unstably not maintained at a specific location of the turbine blade 33 and the stable cooling is maintained in the section from the hub 31 to the tip 32, thus enhancing the entire cooling efficiency of the turbine blade 33.

The turbine blade 33 has the protruded height of the protrusion 130 reduced from the hub 31 toward the tip 32.

Upon rotation of the turbine blade 33, the speed generated at the tip 32 is maintained faster than the speed generated at the hub 31.

Since the hot gas at the tip 32 moves faster than at the hub 31 using the speed difference depending upon the location thereof in the turbine blade 33, the temperature of the turbine blade 33 at the tip 32 can be lower than the temperature of the turbine blade 33 at the hub 31.

In the present embodiment, the protruded height of the protrusion 130 at the tip 32 can be configured to be small or flat using the characteristics of the turbine blade 33. In addition, the protruded length of the protrusion 130 at the hub 31 is extended longer than at the tip 32, thus enhancing the cooling performance by increasing the heat transfer area.

In the present embodiment, the area of the outlet 120 is reduced from the hub 31 toward the tip 32. The opening area of the outlet 120 is generally maintained constantly, but the present embodiment can induce the movement direction of the cooling air sprayed on the surface of the turbine blade 33 to the surface thereof by changing the area of the outlet 120 to variously adjust the spray speed of the cooling air.

When dividing the outer surface 37 into three sections, from the leading edge 34 to the trailing edge 35, a length S includes a first surface section S1 corresponding to the S/3 location based on the leading edge 34, a second surface section S2 corresponding to the 2S/3 location of the bending section (S) from the end portion of the first surface section S1, and a third surface section S3 corresponding to the rest section from the end portion of the second surface section S2 to the trailing edge 35; and the protrusion 130 is formed in the second surface section S2.

In the second surface section S2, the pressure surface 33a corresponds to the section rounded to the inside of the turbine blade 33 based on the drawing.

In addition, the suction surface 33b corresponds to the section rounded and protruded to the outside based on the suction surface 33b of the turbine blade 33.

The configuration of the protrusion 130 is not limited to the shape illustrated in the drawings and may have a circular, polygonal, or D-shaped cross-section, or a combination thereof.

The pressure surface 33a and the suction surface 33b are advantageously enhanced in the cooling performance and the cooling efficiency if the cooling air moves in close contact with the surface without the separation when the cooling air is supplied from the film cooling hole 100 to the blade surface.

For this purpose, the present embodiment includes the protrusion 130 only in the second bending section (S2) of the entire sections of the turbine blade 33, thus enhancing the cooling efficiency.

As an example, the protrusion 130 in accordance with the present embodiment can be located to face each other on the inside walls 121, 122 of the outlet 120, and in this case, this can cause the movement stability enhancement of the cooling air moving along the inside walls 121, 122 and constant flow of the cooling air sprayed on the surface of the turbine blade 33.

If an optimum flow is caused while the cooling air is moved to the outlet 120, a larger amount of the cooling air can be supplied to the surface of the turbine blade 33.

The unnecessary turbulence flow that disturbs a stable flow due to the limited space and the layout while the cooling air passes through the film cooling hole 100 can be caused on the inside walls 121, 122.

However, the present embodiment achieves the stable movement of the cooling air by protruding the protrusion 130 at specific interval and length, thus enhancing the cooling efficiency for the surface of the turbine blade 33.

In addition, as described above, it is possible to guide the movement of the cooling air to the surface of the turbine blade 33, thus stably supplying the cooling air to a specific location where the cooling is required and performing the cooling.

The height of the protrusion 130 in accordance with the present embodiment is linearly increased toward the outlet 120. For example, if the height thereof is linearly increased at a constant rate toward the protrusion located on the inside end portion of the outlet 120 based on the protrusion 130 located at the location firstly contacting with the cooling air, the flow of the cooling air is performed as stable as possible.

In this case, the heat exchange efficiency depending upon the movement of the cooling air is enhanced on the inside surface of the film cooling hole 100, thus it is advantageous in terms of the cooling efficiency.

The film cooling hole 100 is produced to have a low friction coefficient with the inside surface where the contact is made while the cooling air moves. In addition, it is produced to also have a low surface friction coefficient with the protrusion 130.

In this case, the movement stability of the cooling air is enhanced while the cooling air is moved through the outlet 120 via the protrusion 130. In addition, the direction of the cooling air sharply changed during the movement or the loss occurrence due to an eddy current is minimized, thus enhancing the movement stability.

What is claimed is:

1. A gas turbine blade, comprising:
a turbine blade having an outer surface extending between a leading edge and a trailing edge, the outer surface being divided according to surface sections arranged from the leading edge to the trailing edge;
a plurality of film cooling holes formed in the outer surface, each film cooling hole including a cooling channel extending inside the turbine blade to guide cooling air toward the outer surface, and an outlet communicating with the cooling channel to discharge cooling air to the outer surface; and
a protrusion formed on an inside surface of the outlet of at least one film cooling hole disposed in exactly one surface section of the outer surface.

2. The gas turbine blade of claim 1, wherein the outer surface is divided into three surface sections respectively corresponding to thirds of a length of the outer surface from the leading edge to the trailing edge and comprising:
a first surface section arranged adjacent to the leading edge;
a third surface section arranged adjacent to the trailing edge; and
a second surface section arranged between the first and third surface sections, and
wherein the at least one film cooling hole is disposed in the second surface section.

3. The gas turbine blade of claim 2, wherein the protrusion is not present in the film cooling holes formed in the first and third surface sections of the outer surface.

4. The gas turbine blade of claim 1, wherein the inside surface of the outlet is inclined at a predetermined angle with respect to a direction of hot gas moving toward the turbine blade.

5. The gas turbine blade of claim 1, wherein the protrusions of the at least one film cooling hole have a constant height.

6. The gas turbine blade of claim 1, wherein the outlet has one end communicating with the outer surface and wherein the protrusions of the at least one film cooling hole increase in height toward the one end.

7. The gas turbine blade of claim 1, wherein the outlets of the plurality of film cooling holes each have an opening for discharging the cooling air to the outer surface, the openings decreasing in area toward a tip of the turbine blade.
All film cooling holes? or just those in the second surface section?

8. The gas turbine blade of claim 7, wherein
the outlets each include one end communicating with the outer surface of the turbine blade;
a curved portion is provided at the one end of the outlet of a film cooling hole formed in the outer surface of the turbine blade toward the tip of the turbine blade, and
the curved portion is inclined for spraying cooling air onto the outer surface of the turbine blade.

9. The gas turbine blade of claim 1, wherein the outer surface is divided into surface sections respectively corresponding to portions of a length of the outer surface from the leading edge to the trailing edge,
wherein the at least one film cooling hole is disposed in a specific surface section of the divided outer surface, and
wherein the protrusion is not present in the film cooling holes formed in the surface sections of the outer surface excluding the specific surface section.

10. The gas turbine blade of claim 1, wherein the protrusions of the at least one film cooling hole decrease in height toward a tip of the turbine blade.

11. The gas turbine blade of claim 10, wherein the tip of the turbine blade comprises a curved portion to spray cooling air from the outlet onto the outer surface of the turbine blade, the curved portion being inclined at a predetermined angle with respect to a direction of hot gas moving toward the turbine blade.

12. The gas turbine blade of claim 11, wherein the outlet includes two inside surfaces facing each other, and the curved portion includes one of the two inside surfaces.

13. The gas turbine blade of claim 12, wherein the other of the two inside surfaces of the outlet includes a first inclination and is inclined toward the curved portion of the outlet.

14. The gas turbine blade of claim 12, wherein the protrusions are respectively formed on the two inside surfaces of the outlet.

15. The gas turbine blade of claim 1, wherein the outer surface is divided into surface sections respectively corresponding to portions of a length of the outer surface from the leading edge to the trailing edge, the surface sections including a specific surface section of the divided outer surface, and
wherein the film cooling holes are configured differently in the specific surface section than in the surface sections other than the specific surface section.

16. The gas turbine blade of claim 15, wherein the protrusions of the specific surface section are configured differently according to a distance from a hub of the turbine blade.

17. The gas turbine blade of claim 1, wherein the film cooling hole is formed with an inside surface having a low friction coefficient with respect to cooling air moving through the outlet.

18. A gas turbine blade, comprising:
a turbine blade having an outer surface extending between a leading edge and a trailing edge, the outer surface being divided according to surface sections arranged from the leading edge to the trailing edge; and
a plurality of film cooling holes formed in the outer surface, each film cooling hole including a cooling channel extending inside the turbine blade to guide cooling air toward the outer surface, and an outlet communicating with the cooling channel to discharge cooling air to the outer surface,
wherein the outer surface is divided into surface sections respectively corresponding to portions of a length of the outer surface from the leading edge to the trailing edge, the surface sections including a specific surface section of the divided outer surface, and
wherein the film cooling holes are configured differently in the specific surface section than in the surface sections other than the specific surface section.

19. The gas turbine blade of claim 18, wherein the film cooling holes of only the specific surface section are configured differently according to a distance from a hub of the turbine blade.

20. The gas turbine blade of claim 18, further comprising a protrusion formed on an inside surface of the outlet of at least one film cooling hole disposed in the specific surface section.
